(19) United States
(12) Patent Application Publication
(10) Pub. No.: US 2015/0069965 A1
(43) Pub. Date: Mar. 12, 2015

(54) EMBEDDABLE WIRELESS CHARGER

(71) Applicant: E I DU PONT DE NEMOURS AND COMPANY, Wilmington, DE (US)

(72) Inventor: EDDY VERSCHUEREN, MECHELEN (BE)

(21) Appl. No.: 14/481,286

(22) Filed: Sep. 9, 2014

Related U.S. Application Data
(60) Provisional application No. 61/877,037, filed on Sep. 12, 2013.

(51) Int. Cl. H02J 7/02; H02J 7/00

(52) U.S. Cl. CPC H02J 7/025; H02J 7/0042; H02J 7/0052
USPC 320/108; 320/107

(57) ABSTRACT

A system and method is disclosed for integrating an embeddable wireless charger into an item of furniture. An inductor is embedded in a plug of surfacing material, and subsequently they are embedded into a hole in an item of furniture by adhesive bonding. A drive unit is fastened separately to the item of furniture, allowing easy access for servicing.

### BACKGROUND OF THE INVENTION

1. Field of Invention

This invention relates to a wireless inductive charging device for seamless integration into the surface of an item of furniture.

2. Background of the Invention

A system and method is known for inductive charging of devices that use rechargeable batteries. A prior art system is described in US2013/0043833A1 to Katz et al.

A system and method is known for integrating inductive charging functionality into an item of furniture. A prior art system is described in WO2012/093398A3 to Rofe et al., wherein is disclosed an inductive charger that includes a body casing for containing a primary inductor, a driving unit, and a fastening mechanism. Furthermore, it is disclosed that the body casing has dimensions suitable for introduction into a passageway through a plate of the item of furniture. The inductive charger is embedded with flexible adhesive in the passageway in the item of furniture. This method of embedding an inductive charger suffers from the likelihood that people will peel away the flexible adhesive and subsequently the inductive charger will loosen and become damaged.

Also, the body casing is thin and has low impact resistance, leaving the inductive charger easily damaged during normal use of the item of furniture. Another problem is that servicing the drive unit requires fully dismantling the inductive charger.

It is also known to mount an inductive charger on the underside of an item of furniture. In general, this is achieved by removing the body casing and mounting the primary inductor and driving unit under the work-top. This method of mounting suffers from poor charging efficiency as the device to be charged is separated from the coil by the full thickness of the material of the furniture. It is further known to cut a hole in the underside of the furniture, leaving 3 mm or so at the surface, placing the coil and driving unit in the hole, and applying silicone to keep it in place. This method makes it easy to integrate the inductive charger into the furniture and improves the charging efficiency, but suffers from low impact resistance as 3 mm of material is very fragile. Also, there are limitations with some surface materials, such as stone, wherein it is hard to cut back to 3 mm without risk of damaging the entire workpiece into which the hole is being fabricated. Finally, maintenance of the drive unit requires dismantling the entire charger by extracting it from the silicone that is keeping it in place.

There is a need for a way to easily integrate a wireless inductive charger into an item of furniture that is rugged, efficient, and allows for easy maintenance.

### SUMMARY OF THE INVENTION

An embodiment of the invention is an embeddable wireless charger comprising a disk of surfacing material having a first side and a second side, a cavity in said first side, and a wire coil embedded into said cavity.

In another embodiment, the invention is a wireless charging station comprising a panel of surfacing material having a topside and a bottom side with a hole in the panel between the topside and the bottom side, and an embeddable wireless charger adhesively bonded into the hole.

In another embodiment, the invention is a wireless charging station comprising a panel of surfacing material having a topside and a bottom side with a hole in the panel between the topside and the bottom side, and an embeddable wireless charger adhesively bonded into the hole and a drive unit fastened to the bottom side.

In another embodiment, the invention is an embeddable wireless charger comprising an inductor embedded in a cast or molded piece of surfacing material by placing the inductor in a mold and then molding or casting a compound around it.

### BRIEF DESCRIPTION OF THE DRAWINGS

FIG. 1 shows the inductor and drive unit components of the wireless charger.

FIG. 2 shows the embeddable wireless charger.

FIG. 3 shows the fabrication of a hole in the item of furniture.

FIG. 4 shows the adhesive bonding of the embeddable wireless charger into an item of furniture.

FIG. 5 shows the wireless charger embedded into an item of furniture.

### DETAILED DESCRIPTION

The present invention provides an easy solution for integration of a wireless charging unit into surfacing material. The surfacing material may be a part of an item of furniture, such as tables, countertops, vanities, desks, workbenches, bookcases, shelves, wall partitions and the like. The surfacing material may be of any type typically used for furniture or countertops, such as solid surface, quartz surfacing, engineered stone, ceramic tile, stone, high pressure laminate, wood, fiberboard, plywood, or the like. Solid surface materials are found to be an especially preferred material. Corian® solid surface materials from DuPont are an example of solid surface materials.

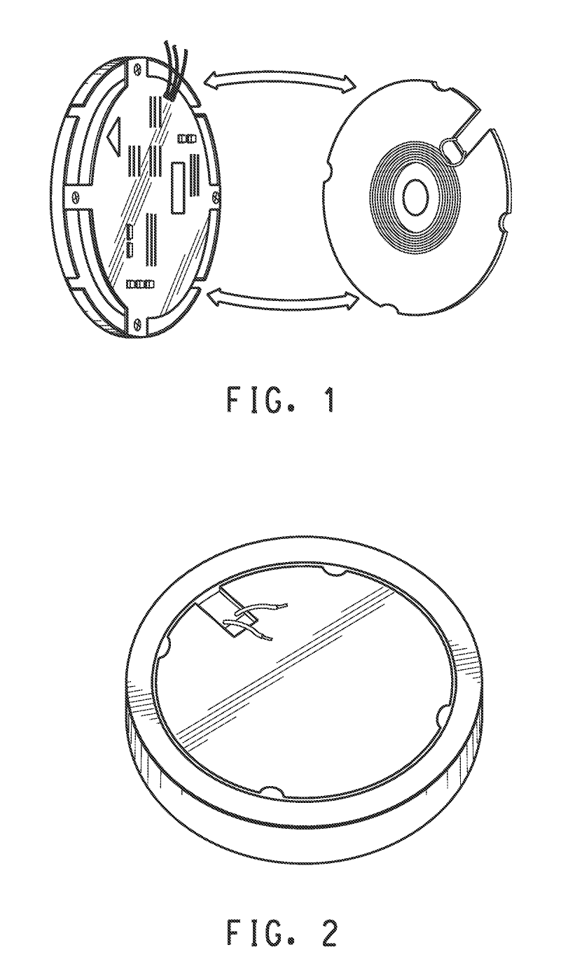

The wireless inductive charging device consists of two components, an inductor and a driving unit, as depicted in FIG. 1. The inductor is an inductive coil, and the drive unit is an electronic system that provides an oscillating driving voltage to the inductor. In the present invention the inductor and drive unit are mounted separately and connected with mating electrical connectors. The inductor is housed in a plug of surfacing material. The plug is adhesively bonded into a hole formed in a surface, then machined flat to the surface. The wireless charger is useful for charging devices with a powerpack and receiving unit, as disclosed in the aforementioned US2013/0043833A1 to Katz et al.

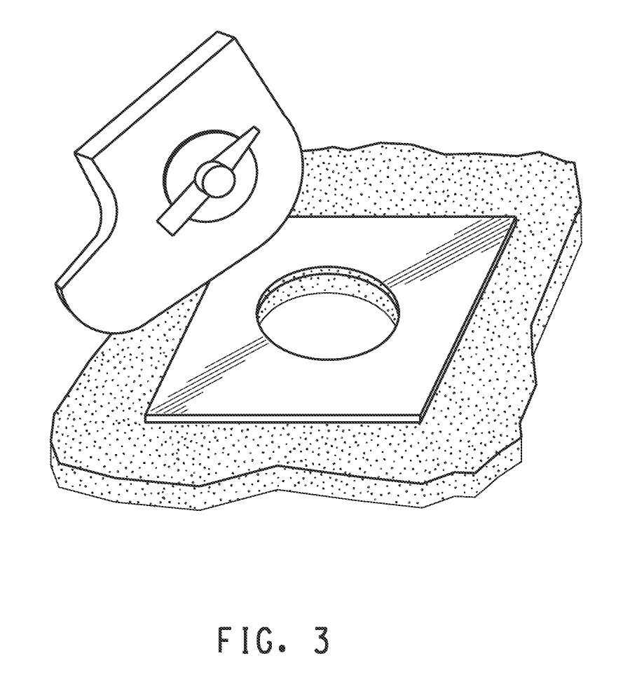

The present invention requires that an inductor be embedded into a cavity formed in a piece of surfacing material. The surfacing material with a cavity for embedding an inductor is herein referred to as a plug. There is no limitation on the shape or size of the plug. A preferred shape is circular, as it allows easy fabrication of the hole in the item of furniture into which the plug will be adhesively bonded. Plugs may be formed by fabrication techniques well known to the woodworking, stone, and solid surface industries, such as drilling a hole partially through the surfacing material, then sawing out the plug. Plugs may also be cast from castable materials. An inductor is embedded into the plug as depicted in FIG. 2. A cavity of sufficient depth and breadth to allow the inductor to be housed within is fabricated in one side of the plug. It is sufficient to use enough adhesive to retain the inductor in normal use, but it is found that increased impact resistance is gained when the cavity is filled with a resin. Similar to the material selected for the item of furniture, the surfacing material used to form the plug may be any material useful for furniture construction, such as solid surface, quartz surfacing, engineered stone, stone, high pressure laminate, wood, fiberboard, plywood, or the like. Solid surface material is preferred as it is easily fabricated, and easy to maintain. Solid surface materials are available in a wide range of colors and aesthetics and make it possible to match the plug to the item of furniture, or to have it contrast which will highlight the wireless charger position. Optionally, the plug may be formed by molding or casting processes, such as bulk molding, injection molding, vibro-compaction, casting, die casting and the like. The inductor may be placed in a mold and then molding or casting compound formed around it. The disk or surfacing material and the cavity are formed in one process and no fabrication step is required to form the cavity. Another option is to embed the inductor in the disk of surfacing material as it is being molded or cast. This eliminates the steps of fabricating the cavity, adhesively bonding the inductor, and the optional step of filling the cavity with resin.

A hole is formed into an item of furniture, into which the plug is adhesively bonded. Any method known to form a hole in the surface is allowed, such as drilling, routing with a template, or CNC machining. The hole formed into the item of furniture must be of the same shape and size as the plug. FIG. 3 depicts a hole machined with a router guided by a template.

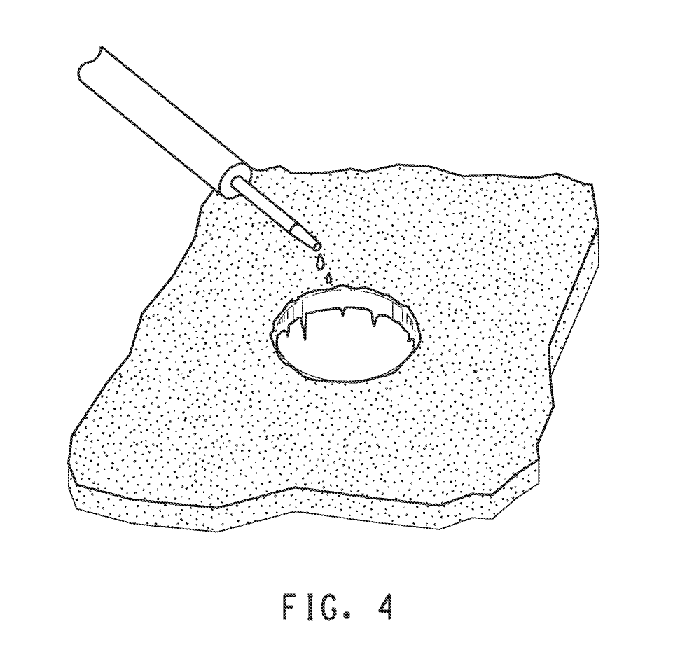

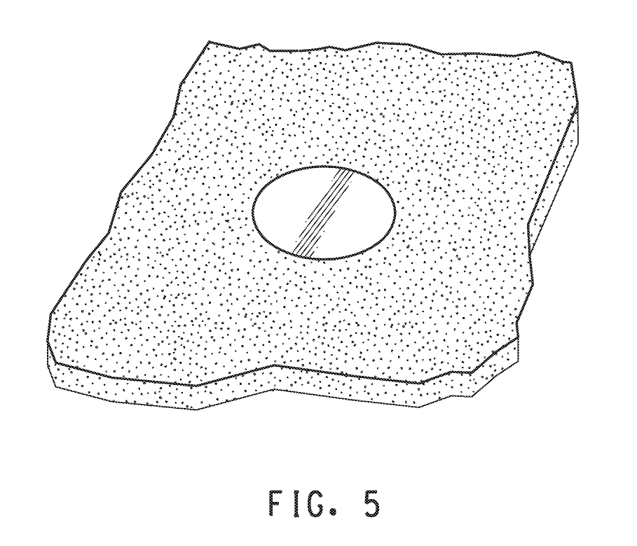

The plug is adhesively bonded into the hole in the item of furniture, with the plug protruding somewhat from the surface, as depicted in FIG. 4. The color of the adhesive may be chosen to match or contrast with that of the plug and item of furniture. Contrasting colors can highlight the wireless charger location. After the adhesive has set, the plug is trimmed off and sanded smooth with the surface of the item of furniture, as depicted in FIG. 5. Any adhesive appropriate for furniture construction may be used, however, a rigid adhesive is preferred as it is tamper-proof relative to flexible adhesives. Solid surface adhesives are preferred with solid surface materials for performance and appearance.

The drive unit may be fastened to the item of furniture at any location that is found to be convenient. It is found to be advantageous to fasten the drive unit inconspicuously on the bottom side of most pieces of furniture. This places the drive unit out of the sight of users of the furniture and leads to less wear to the drive unit. The drive unit may be fastened with adhesive or mechanical fasteners, such as screws.

The embeddable wireless charger of the present invention allows for easy integration into an item of furniture, including retrofitting into existing furniture, with increased impact resistance. Additionally, the present invention provides the benefit of simpler servicing. The inductor is a coil of copper wire that doesn't need any maintenance and therefore can last the lifetime of the item of furniture without need for removal. Whereas the electronics of the drive unit might need upgrade, replacement, or maintenance, the present invention provides an easily removable drive unit that does not require disassembly of the item of furniture.

The scope of the disclosed embodiments may be defined by the appended claims and includes both combinations and sub combinations of the various features described hereinabove as well as variations and modifications thereof, which would occur to persons skilled in the art upon reading the foregoing description.

What is claimed is:

1. An embeddable wireless charger comprising:
(a) a surfacing material disk having a first side and a second side,
(b) a cavity in said first side, and
(c) a wire coil embedded into said cavity.

2. The embeddable wireless charger of claim 1 further comprising a resin that fills said cavity.

3. An embeddable wireless charger comprising an inductor embedded in a cast or molded piece of surfacing material by placing the inductor in a mold and then molding or casting a compound around it.

4. A wireless charging station comprising:
(a) a panel of surfacing material in an item of furniture having a topside and a bottom side.
(b) a hole in said panel between the topside and the bottom side, and
(c) the embeddable wireless charger of claim 2 adhesively bonded into said hole.

5. The wireless charging station of claim 4 further comprising a drive unit fastened to the bottom side.

6. A wireless charging station comprising:
(a) a panel of surfacing material in an item of furniture having a topside and a bottom side.
(b) a hole in said panel between the topside and the bottom side, and
(c) the embeddable wireless charger of claim 3 adhesively bonded into said hole.

7. The wireless charging station of claim 6 further comprising a drive unit fastened to the bottom side.
